(19) United States
(12) Patent Application Publication
(10) Pub. No.: US 2026/0356140 A1
(43) Pub. Date: Nov. 12, 2026

(54) Tool to Facilitate Mounting Airless Bicycle Tires on Rims

(71) Applicant: Nicholas John Ackermann, Middletown, MD (US)

(72) Inventor: Nicholas John Ackermann, Middletown, MD (US)

(21) Appl. No.: 19/669,073

(22) Filed: May 6, 2026

Related U.S. Application Data
(60) Provisional application No. 63/801,326, filed on May 7, 2025.

(51) Int. Cl. B60C 25/02

(52) U.S. Cl. CPC B60C 25/02; B60C 2200/12

(57) ABSTRACT

A tool for mounting airless tires on rims and a method of using the tool. The tool includes an anchoring handle having a grip and a cutout arch to accommodate ingress and egress of an airless tire; and a pressing handle with a grip to receive a pressing force supplied by an operator, a punch tip, and an arch to removably receive the airless tire. The anchoring handle and the pressing handle are coupled together at a pivot point and free to pivot around a pivot axis of the pivot point. A force applied by the operator at the grip is translated to a greater force at the punch tip determined by a force multiplier defined by a ratio of a distance from the pivot axis to the punch tip to a distance from the pivot axis to the grip portion of the pressing handle.

### CROSS-REFERENCE TO RELATED APPLICATIONS

This application claims the benefit of U.S. Provisional Patent Application Nos. 63/801,326 (filed on May 7, 2025), the contents of which are incorporated herein by reference in its entirety.

### BACKGROUND

The present disclosure relates to tools for repairing bicycle tires. More particularly, the present disclosure relates to a tool to facilitate mounting airless bicycle tires on rims.

A type of bicycle tire has become available that is made of solid rubber and does not rely on pneumatic inflation to perform its function. It is secured to the rim of a bicycle wheel by means of several dozen hard plastic clips which pass through small slots through the tire from one side to the other. The clips are supplied in different lengths to accommodate different rim widths, so that the ends of the clips, when the tire is fully installed, press against the left and right inner sidewall of the rim, and also the bent-over lip at the top of each rim sidewall. A hand tool of similar shape to a railroad spike is usually supplied with the tire and clips to aid in pressing the tire into the rim until the clip ends snap into place under the rim lip. This requires firmly grasping the tool and pushing hard enough that wrist fatigue and pain are common consequences.

### BRIEF DESCRIPTION OF THE DRAWINGS

FIG. 1 illustrates an isometric view of a tool for mounting airless bicycle tires on rims, in accordance with an embodiment of the present disclosure.

FIGS. 2 and 3 depict opposing flat sides of the too, in accordance with an embodiment of the present disclosure.

FIGS. 4 and 5 show opposing ends of the tool, in accordance with an embodiment of the present disclosure.

FIGS. 6 and 7 illustrate top and bottom opposing views of the tool, in accordance with an embodiment of the present disclosure.

FIG. 8 illustrates an isometric view of the tool, in accordance with an embodiment of the present disclosure.

FIG. 9 illustrates use of the tool in situ, in accordance with an embodiment of the present disclosure.

FIGS. 10A and 10B show positioning of the tool with respect to a tire to be mounted on a rim, in accordance with an embodiment of the present disclosure.

FIG. 11 shows a further isometric view of the tool in a closed position, in accordance with an embodiment of the present disclosure.

FIG. 12 shows a further isometric view of the tool in an open position, in accordance with an embodiment of the present disclosure.

FIGS. 13-28 illustrate use of the tool to mount airless tires on rims, in accordance with an embodiment of the present disclosure.

FIG. 29 illustrates an alternative embodiment of a toll to mount airless tires on rims, in accordance with an embodiment of the present disclosure.

### DETAILED DESCRIPTION

Embodiments of the present disclosure will now be described with reference to the drawing figures, in which like reference numerals may be used to refer to like parts throughout.

The figures described herein depict and explain the function of a novel improved tool which employs lever advantage to press in the tire and securing clips with less physical effort than is required for the preexisting method that employs the tool shaped like a railroad spike. Once the clips have been inserted in the tire slots (transverse holes or slots) in a transverse arrangement extending between the sidewalls of the airless tire and the tire has been stretched around the rim with one side of the airless tire seated deeply enough that the clips on that side are under the rim wall lip, the mounting tool can be used to press in the other end of each clip. As used herein, airless tires, as opposed to tires with air, may also be referred to as solid tires.

Therefore, in accordance with certain embodiments described herein, a tool that facilitates mounting of airless tires on rims is provided, the tool having an anchoring handle and a pressing handle. Also provided in accordance with embodiments described herein is a method for mounting airless tires on rims.

With regard to the tool, there is provided an anchoring handle having a grip portion at a first end distal from a second end and a cutout arch configured to accommodate ingress and egress of an airless tire removably placed within the cutout arch of the anchoring handle. The pressing handle has a grip portion at a first end configured to receive a pressing force supplied by an operator to the pressing handle, a punch tip at a second end, and an arch coupled to the punch tip and configured to removably receive the airless tire, the first end distal from the second end. The second ends of the anchoring handle and the pressing handle are coupled together at a pivot point distal the respective first ends of the anchoring handle and the pressing handle, with the anchoring handle and the pressing handle free to pivot around a pivot axis of the pivot point. A force applied by the operator at the grip portion at the first end of the pressing handle is translated to a greater force at the punch tip determined by a force multiplier defined by a ratio of a distance from the pivot axis to the punch tip to a distance from the pivot axis to the grip portion at the second end of the pressing handle.

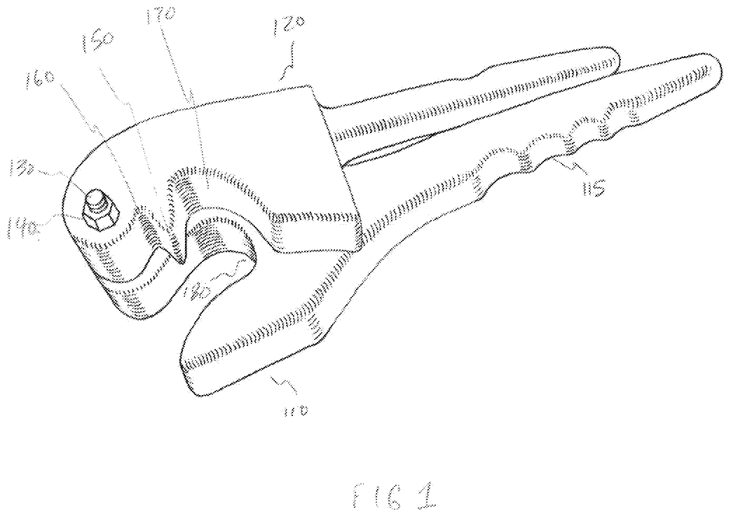

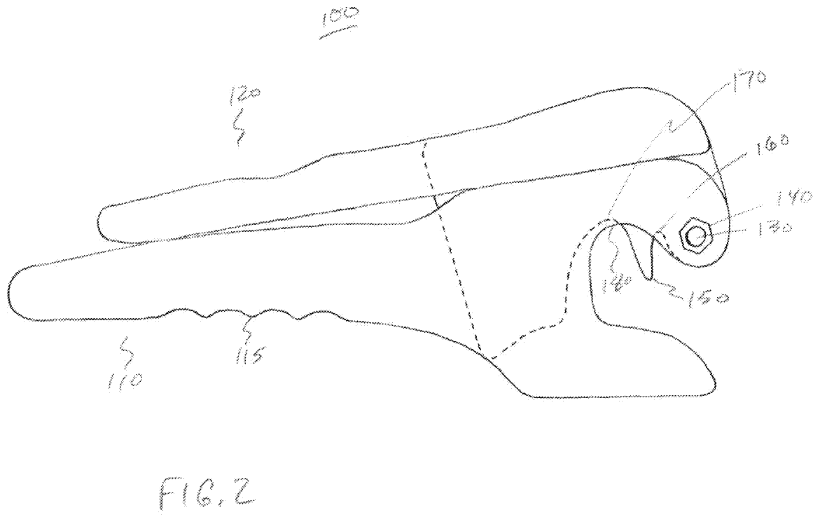

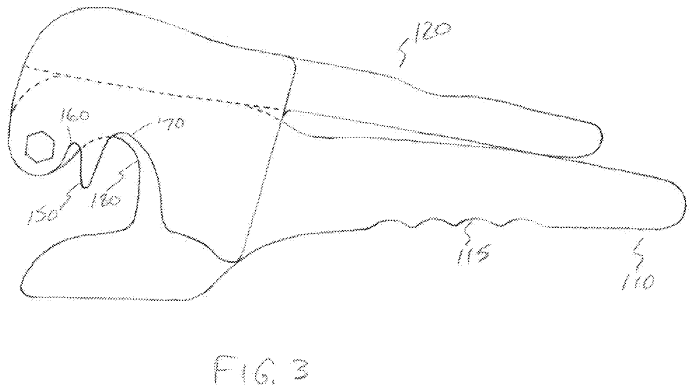

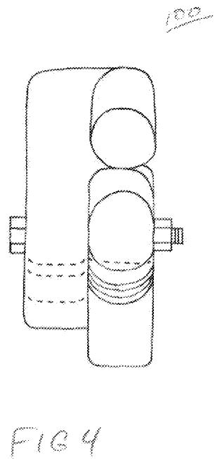

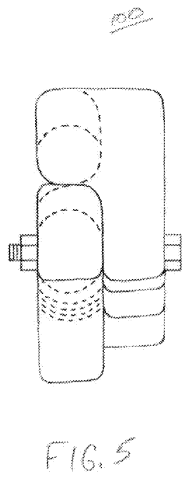

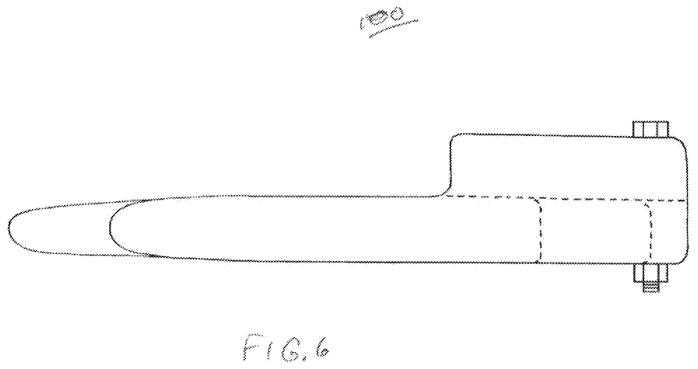

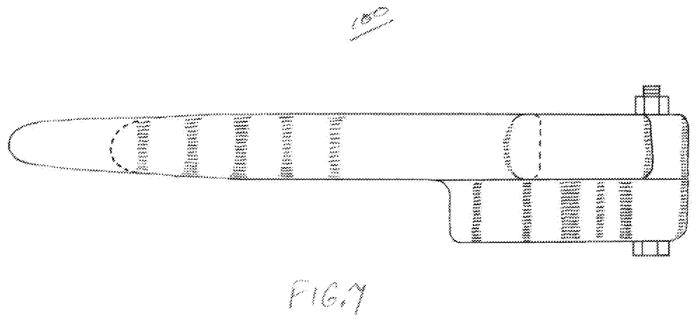

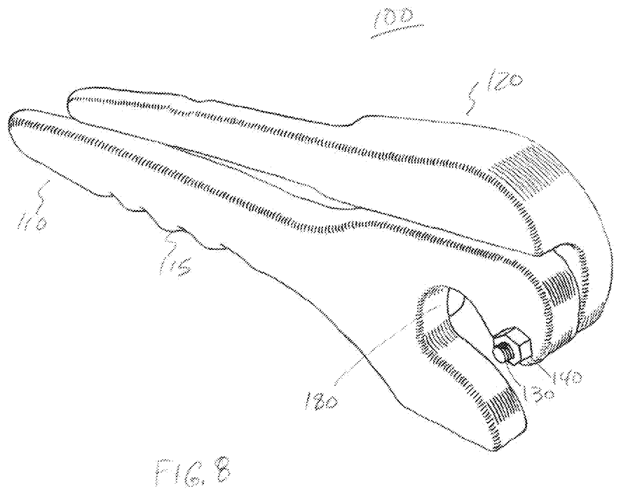

In accordance with FIGS. 1-8, and further drawings described herein, an example tool 100 for mounting airless bicycle tires on rims is illustrated. FIG. 1 shows an isometric view of the tool. FIGS. 2 and 3 illustrate opposing flat sides of the tool. FIGS. 4 and 5 illustrate opposing ends of the tool. FIGS. 6 and 7 illustrate top and bottom opposing views of the tool. FIG. 8 illustrates an isometric view of the tool. Certain changes in the shape and design of the tool may be made without significantly affecting the functional aspects of the tool described below.

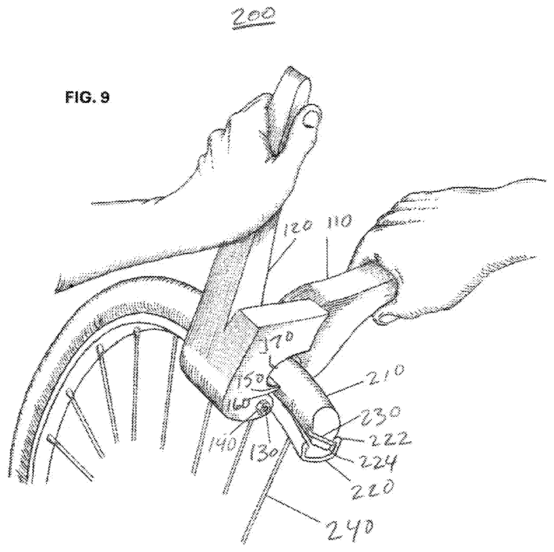

Referring now to usage 200 shown in FIGS. 9, 10A, 10B, and 11, it can be seen that the tool comprises two parts, an anchoring handle 110, with grip 115, and a pressing handle 120, each having certain features that together facilitate the mounting of an airless tire 210 on a rim 220, such as a bicycle rim. The anchoring handle 110 and the pressing handle 120 are coupled together via a pivot point of the tool, such as pivot screw 130 with nut 140, around which they are free to pivot. Both or either of the anchoring handle 110 and the pressing handle 120 can be fabricated from a variety of materials so long as they are strong enough to handle the force required when using the tool to mount an airless tire 210 on a rim 220 without causing harm to the airless tire 210 and/or the rim 220. Examples of suitable materials include oak, valued for its resistance to splitting under stress; 5052 aluminum; or injection molded or centrifugal molded hard plastic such as Acrylonitrile Butadiene Styrene (ABS, used in Lego® bricks), polypropylene, or polycarbonate, all of which are unlikely to cut, puncture, chafe or otherwise harm the integrity of tire rubber used for airless bicycle tires 210 or of the rim 220. On a oak prototype, for example, for durability, care was taken to align the wood grain in the punch tip 150 with the direction of applied force, to reduce the risk of the tool splitting the wood under load when used. For longer wear and extended tool life, a ¼-20 machine screw 130 could be fitted through bushings pressed into the two handles 110 and 120 and secured with nut 140, also ¼-20 threaded and taking a 7/16 wrench, for example. The prototype tool measured 12.0 inches in overall length, 4.25 inches high, and 3 inches thick. The weight of the tool as prototyped was about 2.2 pounds in 5052 aluminum or cast aluminum, about 0.65 pounds in oak, and 0.83 pounds in ABS plastic, for example. The distance from the pivot axis, the centerline of the pivot screw 130 to the punch tip 150 may be about one tenth of the distance from the pivot axis to the location where the operator applies force to the grip portion the pressing handle 120, defining a force multiplier of the force applied at the pressing handle that is translated and applied at the punch tip 150. Consequently, when approximately 4 to 6 pounds of force are applied to the pressing handle 120, for example, the tool generates approximately 40 to 60 pounds of force at the punch tip 150 which forces the clip into place with an audible click. Because of the lever arm advantage provided by this force multiplier upon actuation of the punch tip of pressing handle 2, the risk of wrist fatigue and pain is minimized or eliminated. The pivot screw 130 of an example prototype was a ¼-20 thread Grade 5 machine screw (ASTM A 449-Type 1 medium carbon steel). This steel has a shear modulus of 10,400-11,900 ksi, so that the operating shear stress on the screw shank in operation of this tool would be about one ninth of its shear modulus. This safety margin would be even greater with the use of a Grade 8 screw (SAE J429 medium carbon alloy steel) but this was deemed unnecessary “overkill,” as the handle material would, in a case of drastically excessive force applied on the tool, fail before the screw 130 failed.

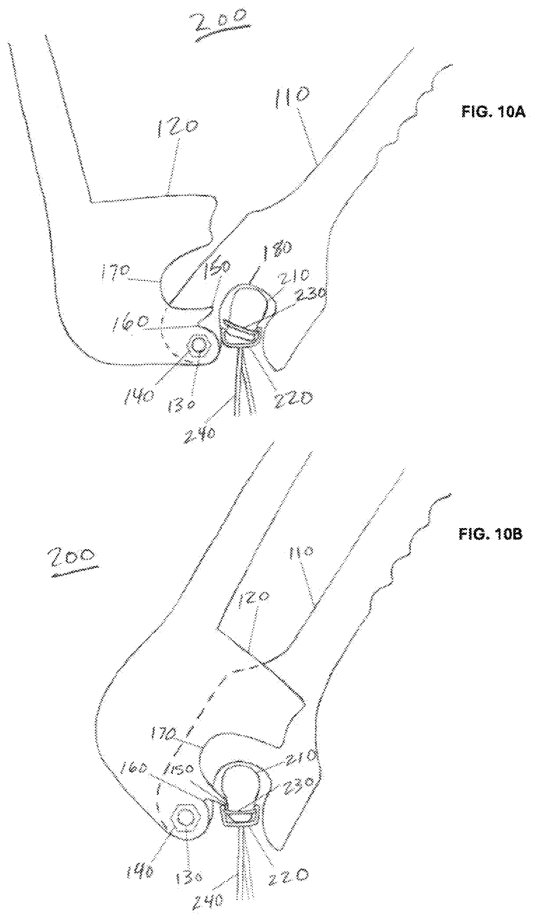

The operator first opens the tool so the handles are farther apart by separating the anchoring handle and the pressing handle about the pivot point, like pivot screw 130, of the tool. For example, an included angle of separation between anchoring handle 110 and pressing handle 120 of approximately 40 degrees as shown in FIG. 10A is sufficient to permit ingress and egress of a 700-23 C or 700-25 C airless tire, for example, into the anchoring handle cutout arch 180 without interference from the pressing handle 120 punch tip 150, as shown in FIG. 9 and FIG. 10A. This action of placing the anchoring handle on the tire 210 positions the tire inside the cutout arch 12 where it can rest as shown, and the punch tip 150 is positioned slightly above the protruding end of the plastic clip 230 as shown in FIG. 9 and FIG. 10B, with one or more clips positioned transverse opposing sidewalls 224 of the airless tire 210. The pressing handle 120 is then brought closer to the anchoring handle by rotating it about the pivot screw 130 into a punching position with punch tip 150 positioned at a sidewall 224 of the airless tire 210 slightly above the protruding end of the clip 230, from which an operator presses the punch tip to press the sidewall 224 of the tire 210 inward and downward until the clip 230 seats under the rim wall lip 222 with a click sound. The operator then moves the tool to the next clip and repeats the sequence of steps. In this way, all of the clips can be pressed into place in as little as one-tenth of the time formerly required using the traditional railroad spike-shaped tool.

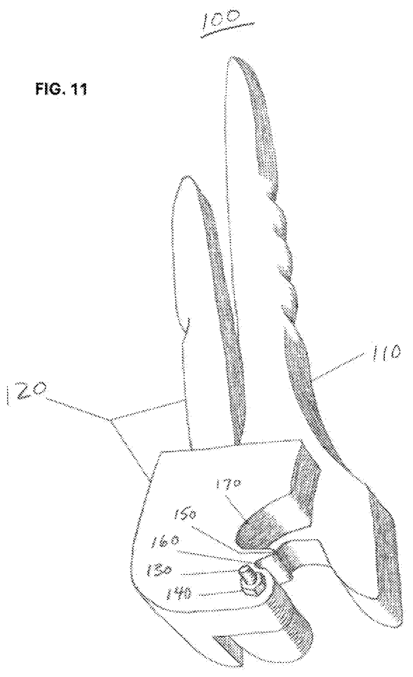

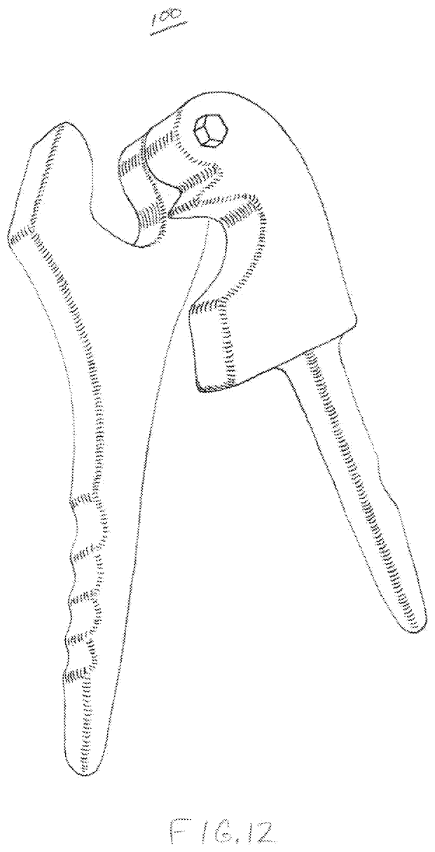

FIG. 11 is a three-dimensional isometric representation of the tool 100, clearly showing the details of the pressing handle 120 of the tool, while FIG. 12 illustrates the tool 100 in an open position.

Novel features of this tool 100 include at least the following. First, the shape of the cutout arch 180 in the anchoring handle 110, which allows gripping of the tire 210 but also allows some freedom of adjustment of the handle position and angle for optimal effect when pressing the clip into the tire rim 220. The tool 100 as developed is made to fit a tire size of 700-25 C and a tire size of 700-23 C, but other sizes can be accommodated and are contemplated by having interchangeable anchor handles 110 with different-sized arch cutouts 180 to grip different-sized tire profiles.

Second, the punch tip 150 has a sharp enough point to sufficiently concentrate the pressure on the tire 210, but not so sharp as to cut into the tire. It is positioned at the right distance from the axis screw 130 so that it applies pressure in the right place and in the right direction, inward from the side transitioning to downward toward the axle as the handles are brought closer to one another, to achieve the desired result of securely installing the hard plastic clip within the tire rim 220. In example embodiments, the clips 230 are made and supplied by the tire manufacturer Tannus, made of beveled hard plastic material and have adequate flexion at their ends to permit the ends of the clips to be forced into opposing transverse slots of the airless tire 210 upon application of sufficient force to the grips of the pressing handle that is translated to the punch tip 150, as shown. The clips 230 have sufficient hardness to hold position and are flexing enough to be snapped into place using tool 100. Plastic clips 230 may be preferable to metal clips in certain implementations, as they do not scratch aluminum alloy rims, do not corrode, and are probably less costly than metal clips. It is noted that tool 100 presses the clips 230 indirectly, by applying force to the sidewall 224 of the tire 210. If the clips weren't beveled, the system (including the tool) may not work as well or as easily. The clips are just the right hardness to hold position and be durable while flexing enough to be snapped into place using the tire tool. Plastic clips may be preferable to metal clips as they do not scratch aluminum alloy rims, do not corrode, and are probably less costly than metal clips.

Third, the pressing handle arch 170 is sized and located to accommodate the tire 210 during the pressing procedure. For larger profile tires, the pressing handle 120 could be swapped out with one with a larger arch 170 to accommodate the larger tire during pressing.

Fourth, the rim wall cutout 160 in the pressing handle 120 is sized and positioned to accommodate the rim wall 224 of the rim 220 during the pressing procedure. Alternate pressing handles for larger tires would accordingly have the pressing punches located ideally for the rim that carries those tires.

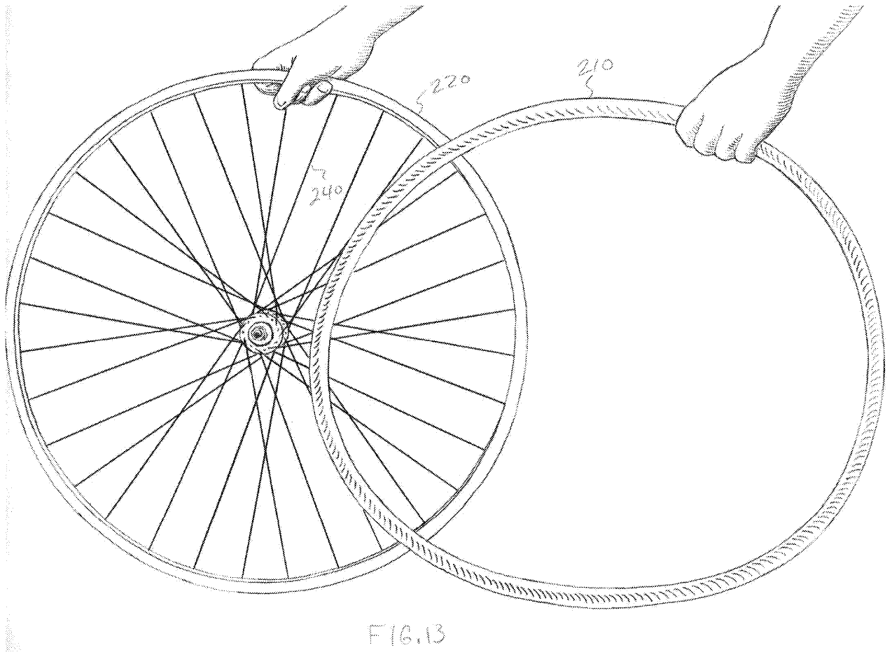

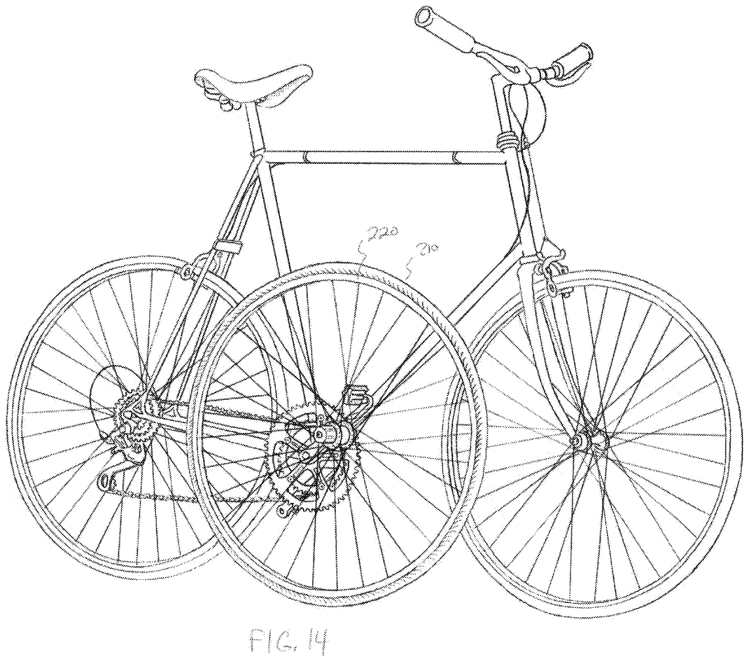

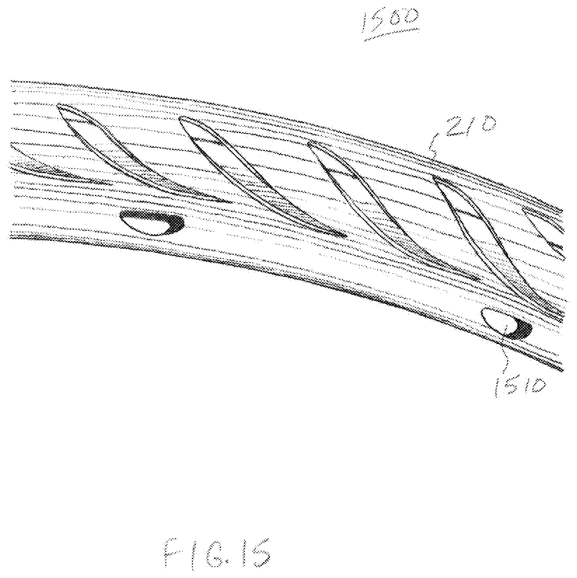

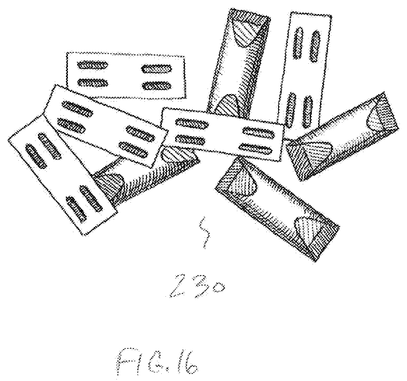

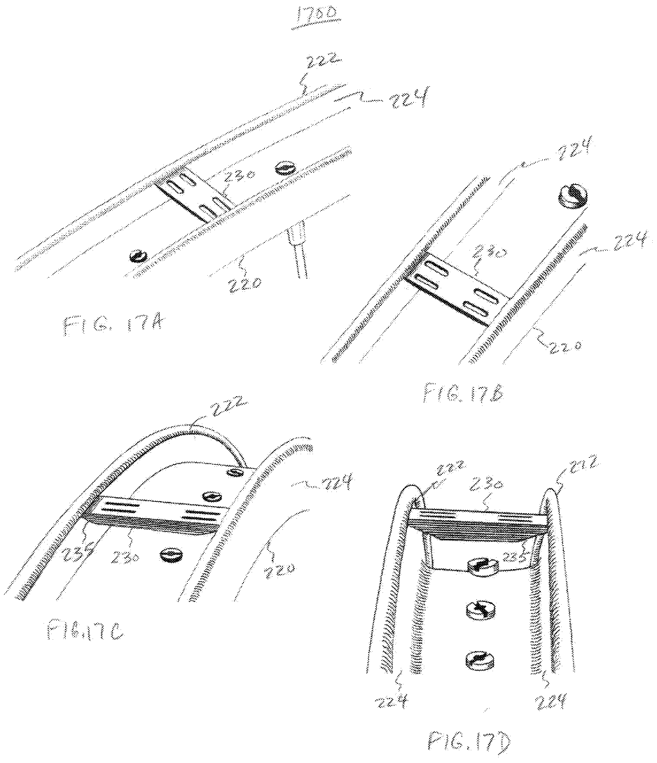

FIGS. 13-28 illustrate use of the tool in an improved process and methodology for mounting airless bicycle tires on rims. FIG. 13 illustrates a solid tire 210 before being mounted on rim 220. FIG. 14 illustrates a solid tire 210 mounted on a rim 210, shown next to a fully equipped bicycle. FIG. 15 shows an illustration 1500 of a side view of unmounted solid tire 210 showing transverse holes (slots) 1510 for retaining clips 230. FIG. 16 shows hard plastic retaining clips 230 which fit in transverse holes in solid tires 210 to secure the tire to the rim 220. Referring now to FIGS. 17A, 17B, 17C, and 17D, illustrations 1700 show an example orientation of a clip 230 when a tire 210 has been fully installed (tire not shown for clarity). Note that the clip ends are underneath rim flange lip 222 on both sides of the rim 220 and the clip's beveled surfaces 235 face towards the rim 220.

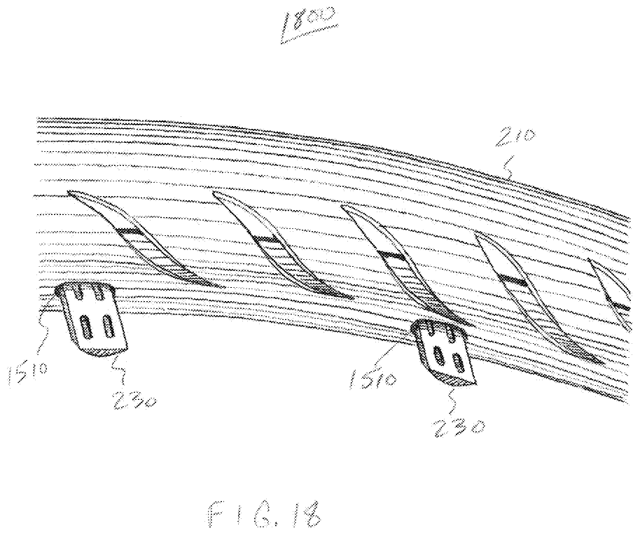

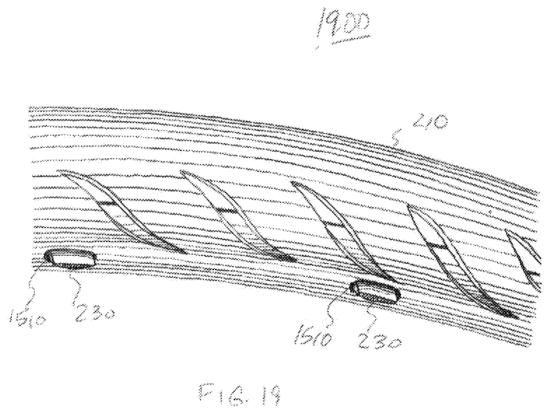

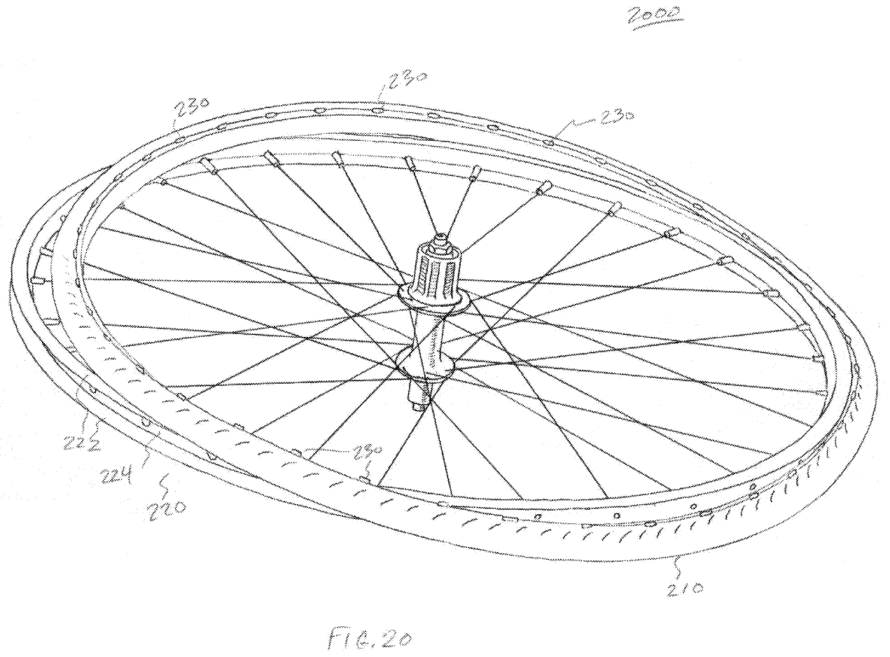

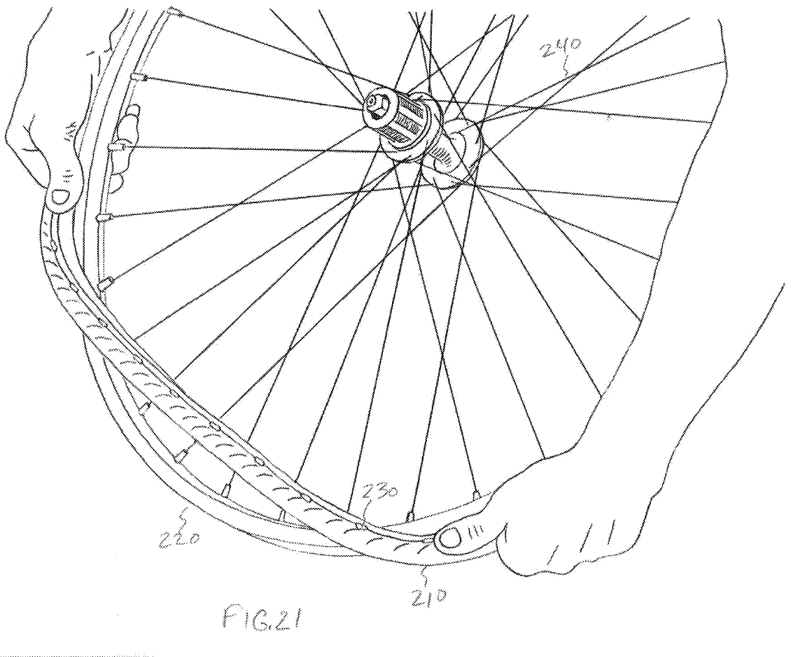

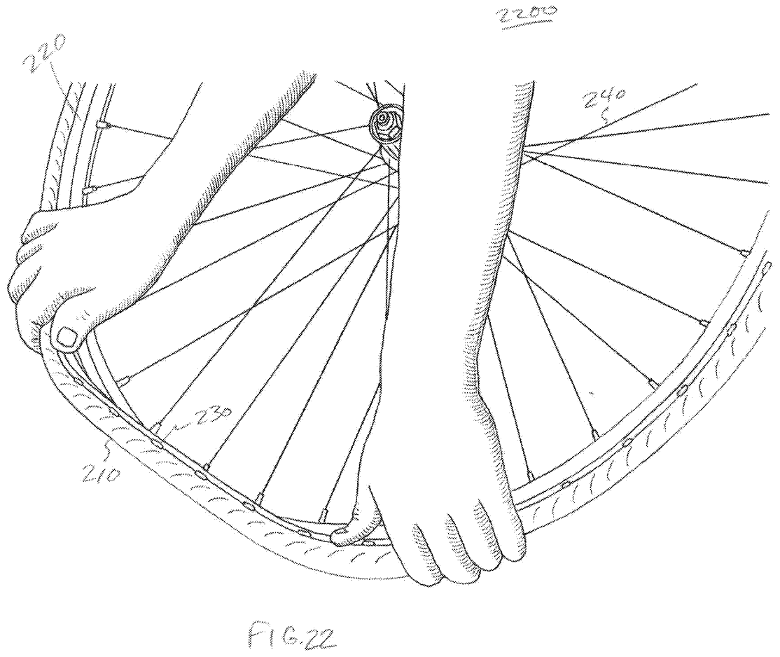

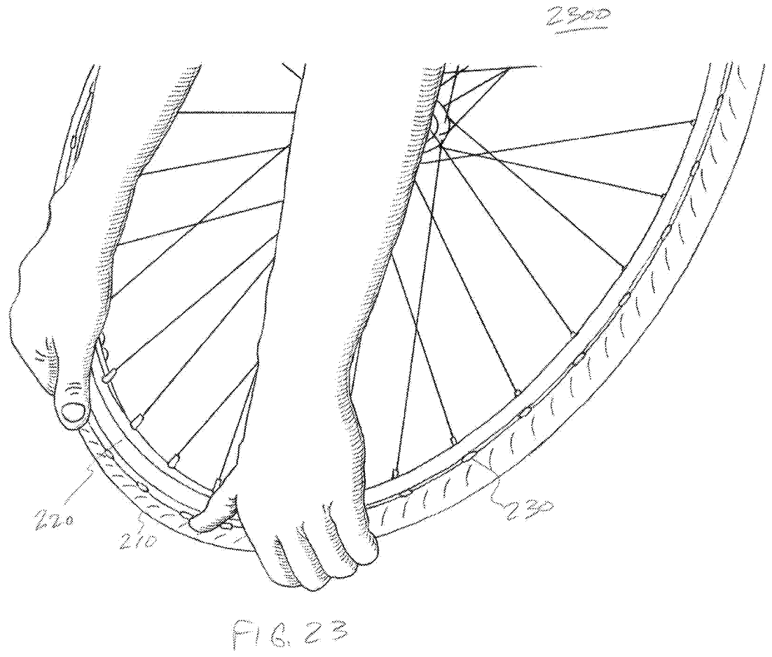

Referring now to FIGS. 18-29, the illustrations of mounting a solid tire onto a rim are illustrated in a step-by-step fashion. In illustration 1800 of FIG. 18, clips 230 are partially inserted into transverse holes 1510 in an unmounted tire 210. In illustration 1900 of FIG. 19, clips 230 are fully inserted into transverse holes 1510 in tire 210, the clips shown protruding equally on each side. After the clips 230 are inserted in each of the paired transverse holes 1510, the tire 210 is ready to be stretched around rim 220, shown in FIGS. 20-23. In FIG. 20, illustration 2000 shows tire 210 laid loosely over rim 210, with each of the transverse slots or holes 1510 filled with clips 230, the tire now ready to be stretched around rim 210. Illustration 2100 of FIG. 21 shows tire 210 about three-quarters seated on rim 220, while illustration 2200 of FIG. 22 illustrates tire 210 about 90-percent seated on rim 220. Finally, in illustration 2300 of FIG. 23, tire 210 is fully seated on rim 220, with the clip ends of clips 230 under rim flange lip 222 on far side, but still visible outside rim 224 on near side, where the clip ends will have to be pressed into place with the improved mounting tool 100.

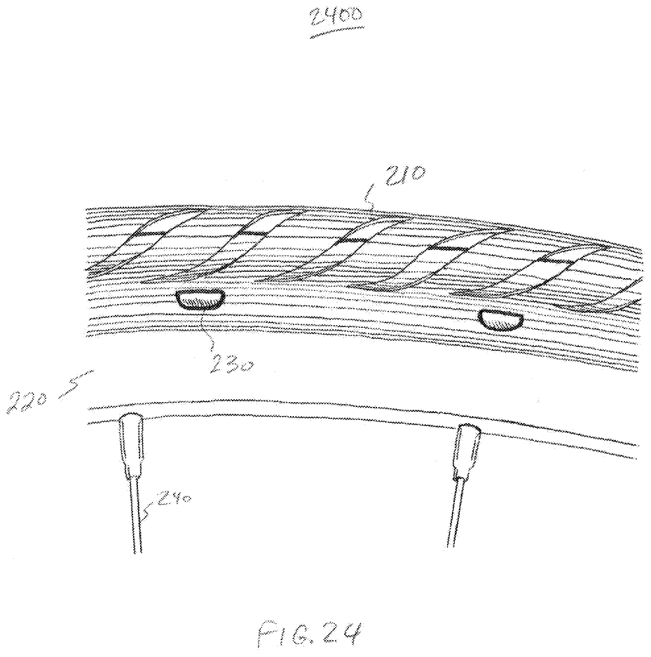

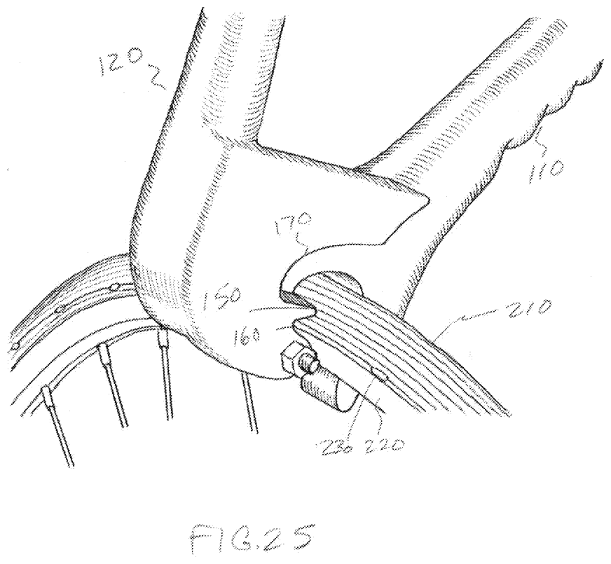

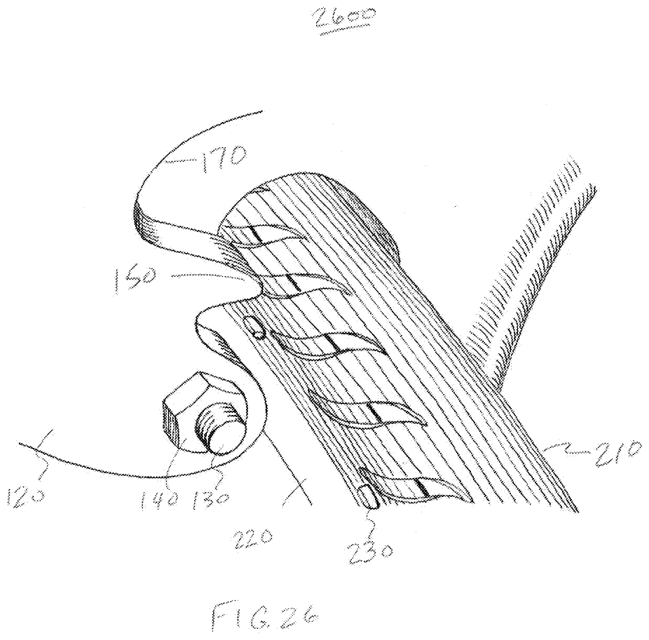

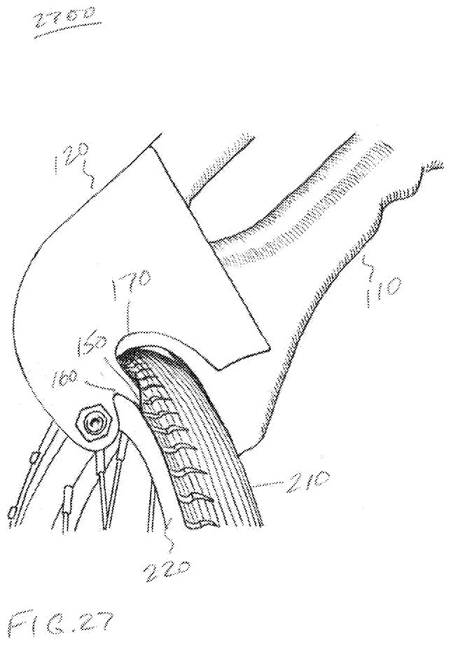

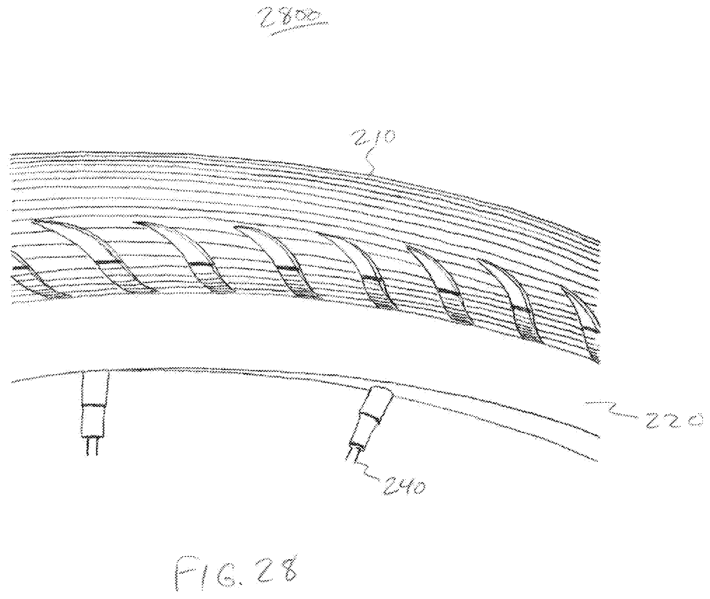

Illustration 2400 of FIG. 24 shows a close-up of the side of tire 210 before pressing the clip ends of the clips 230 down into rim 220 and under sidewall flange lip 222. Illustration 2500 of FIG. 25 provides a depiction of tool 100 in place with the anchor handle 110 gripping the tire 210 and punch tip 150 ready to press clip 230 into place. Illustration 2600 of FIG. 26 provides a close-up of the position of punch tip 150 against tire 210 before pressing clip 230 into place. Note that the clip end of clip 230 is visible just below punch tip 150. Note further that punch tip 150 initially presses in from the side of the tire 210. This is followed by illustration 2700 of FIG. 27 that shows the tool position after the clip 230 has been pressed into place. Note that the punch tip pressure applied by the operator has steadily changed from inwards to downwards. In illustration 2800 of FIG. 28, a side view of tire 210 after clips 230 have been pressed into place is shown. The clips 230 have been firmly clipped into place by tool 100 and are not visible. Only tire 210 and the sidewall of rim 220 are shown.

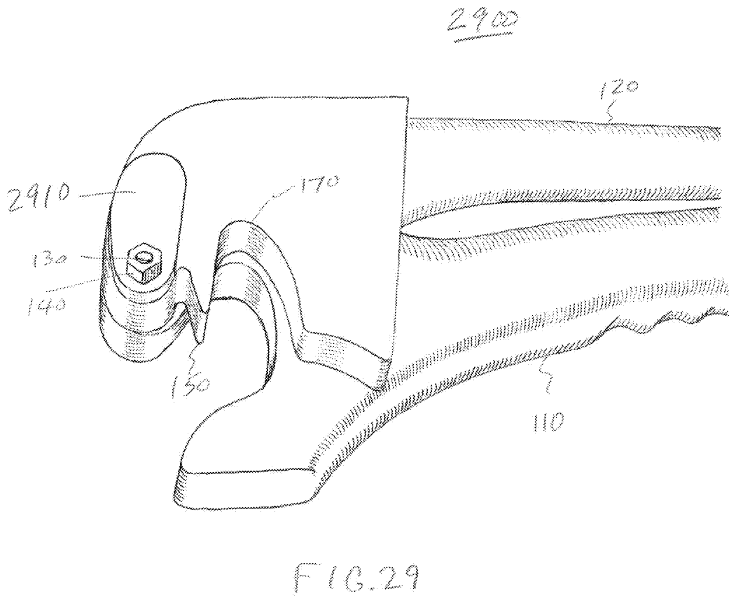

Referring now to FIG. 29, an alternate embodiment of tool 2900 is shown. In this embodiment, an extra platform 2910 supports the pivot axis hex nut and adds perpendicular grain for strength in an wooden (oak) version of the tool.

In view of the above description and accompanying drawings, a method for mounting airless tires on rims is provided, including: removably placing an airless tire within a cutout arch of an anchoring handle of a tool in an open position of the tool, the airless tire having a plurality of clips placed in slots of the airless tire in a transverse arrangement between the sidewalls of the airless tire; rotating a pressing handle of the tool about a pivot point of the tool at which the anchoring handle and the pressing handle are coupled towards the airless tire to place an arch of the pressing handle over the airless tire and to position a punch tip of the pressing handle at a location of the sidewall of the airless tire adjacent a clip of the plurality of clips in a closed position of the tool; and responsive to an operator applying a force to a grip portion of the pressing handle, translating the applied force to a greater force determined by a force multiplier defined by a ratio of a distance from a pivot axis of the pivot point to the punch tip to a distance from the pivot axis to the grip portion of the pressing handle and the punch tip of the tool applying the greater force to the location of the sidewall of the airless tire adjacent the clip to seat the clip under a rim wall lip of a rim wall of a rim.

While implementations of the disclosure are susceptible to embodiment in many different forms (such as a larger cutout in the anchor handle and pressing handle to accommodate a fatter or taller tire), there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A tool that facilitates mounting of airless tires on rims, comprising:
an anchoring handle having a grip portion at a first end distal from a second end and having a cutout arch configured to accommodate ingress and egress of an airless tire removably placed within the cutout arch of the anchoring handle; and
a pressing handle having a grip portion at a first end configured to receive a pressing force supplied by an operator to the pressing handle, a punch tip at a second end, and an arch coupled to the punch tip and configured to removably receive the airless tire, the first end distal from the second end, the second ends of the anchoring handle and the pressing handle coupled together at a pivot point distal the respective first ends of the anchoring handle and the pressing handle, the anchoring handle and the pressing handle free to pivot around a pivot axis of the pivot point,
where a force applied by the operator at the grip portion at the first end of the pressing handle is translated to a greater force at the punch tip determined by a force multiplier defined by a ratio of a distance from the pivot axis to the punch tip to a distance from the pivot axis to the grip portion at the second end of the pressing handle.

2. The tool of claim 1, where the pivot point of the tool is a pivot screw.

3. The tool of claim 1, where the force multiplier is defined by a ratio of approximately one-tenth, with the distance from the pivot axis to the punch trip at the second end of the pressing handle approximately one-tenth of the distance from the pivot axis to the grip portion at the first end where the operator applies force to the pressing handle.

4. The tool of claim 1, where responsive to the operator securing the airless tire within the cutout arch of the anchoring handle and the arch of the pressing handle in an open position of the tool, positioning the punch tip at a location of a sidewall of the airless tire that is adjacent to a clip of a plurality of clips placed in slots of the airless tire in a transverse arrangement between the sidewalls of the airless tire in a closed position of the tool, and applying the force to the grip portion of the pressing handle, the punch tip is configured to apply the greater force to the location of the sidewall adjacent the clip to seat the clip under a rim wall lip of a rim wall of a rim.

5. The tool of claim 4, where the airless tire is configured to be stretched over and be removably retained on the rim by the plurality of clips in the transverse arrangement in slots between the sidewalls of the airless tire.

6. The tool of claim 4, where the punch tip is configured to apply the greater force to the location of the sidewall adjacent the clip inward from the sidewall and downward.

7. The tool of claim 4, where in the open position of the tool, an angle of separation between the anchoring handle and the pressing handle about the pivot point is approximately 40 degrees.

8. The tool of claim 1, the pressing handle further including a rim wall cutout configured to accommodate a rim wall of a rim during mounting of the airless tire received in the arch of the pressing handle.

9. The tool of claim 8, the rim wall cutout coupled to the punch tip of the pressing handle and the pivot point.

10. The tool of claim 9, the rim wall cutout arranged between the punch tip of the pressing handle and the pivot point.

11. A method for mounting airless tires on rims, comprising:
removably placing an airless tire within a cutout arch of an anchoring handle of a tool in an open position of the tool, the airless tire having a plurality of clips placed in slots of the airless tire in a transverse arrangement between the sidewalls of the airless tire;
rotating a pressing handle of the tool about a pivot point of the tool at which the anchoring handle and the pressing handle are coupled towards the airless tire to place an arch of the pressing handle over the airless tire and to position a punch tip of the pressing handle at a location of the sidewall of the airless tire adjacent a clip of the plurality of clips in a closed position of the tool; and
responsive to an operator applying a force to a grip portion of the pressing handle, translating the applied force to a greater force determined by a force multiplier defined by a ratio of a distance from a pivot axis of the pivot point to the punch tip to a distance from the pivot axis to the grip portion of the pressing handle and the punch tip of the tool applying the greater force to the location of the sidewall of the airless tire adjacent the clip to seat the clip under a rim wall lip of a rim wall of a rim.

12. The method of claim 11, further comprising prior to removably placing the airless tire within the cutout arch of the anchoring handle:
opening the tool so that a punch tip of a pressing handle of the tool coupled to the anchoring handle at a pivot point does not block egress and ingress of the airless tire in the cutout arch of the anchoring handle.

13. The method of claim 12, where opening the tool includes separating the anchoring handle and the pressing handle about the pivot point by an angle of separation.

14. The method of claim 13, where the angle of separation between the anchoring handle and the pressing handle in opening the tool is approximately 40 degrees.

15. The method of claim 11, where positioning the tool to the punching position includes bringing a cutout arch of the pressing handle into position over the airless tire.

16. The method of claim 15, where positioning the tool further includes accommodating a rim wall of the rim.

17. The method of claim 16, where positioning the tool further includes positioning the rim wall of the rim within a rim wall cutout of the pressing handle.

18. The method of claim 11, further comprising prior to removably placing the airless tire within the cutout arch of the anchoring handle:
placing each of the clips of the plurality of clips through two opposing slots of the airless tire in the transverse arrangement between first and second sidewalls of the airless tire with first ends of the plurality of clips protruding through slots of the first sidewall of the airless tire and with second ends of the plurality of the clips protruding through slots of the second sidewall of the airless tire, where the two opposing slots for each clip of the are arranged in parallel around the perimeter of the rim; and
stretching airless tire around the perimeter of the rim to place a plurality of the first ends of the plurality of clips under a rim wall lip of a first rim wall of the rim.

19. The method of claim 18, further comprising after the removably placing the airless tire within the cutout arch of the anchoring handle for each clip of the plurality of clips:
rotating the pressing handle of the tool about the pivot point of the tool towards the airless tire to place the arch of the pressing handle over the airless tire and to position the punch tip of the pressing handle at a location of the sidewall of the airless tire adjacent the second end of a clip of the plurality of clips in a closed position of the tool; and
responsive to the operator applying the force to the grip portion of the pressing handle, translating the applied force to the greater force and the punch tip of the tool applying the greater force to the location of the sidewall of the airless tire adjacent the second end of the clip to seat the second end of the clip under a rim wall lip of a second rim wall of the rim.
